(19) United States
(12) Patent Application Publication
(10) Pub. No.: US 2005/0036057 A1
(43) Pub. Date: Feb. 17, 2005

(54) Image pickup device integrated with lens, method and apparatus for manufacturing the same

(75) Inventors: Kazuya Ushirokawa, Ibaraki-shi (JP); Isamu Aokura, Osaka-shi (JP); Koujirou Nakamura, Ibaraki-shi (JP); Hidenobu Nishikawa, Ikoma-shi (JP); Tomonori Itoh, Kyoto-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/898,522

(22) Filed: Jul. 23, 2004

(30) Foreign Application Priority Data
Jul. 24, 2003 (JP) 2003-278971

(51) Int. Cl. H04N 5/225

(52) U.S. Cl. 348/340

(57) ABSTRACT

The present invention of a manufacturing method and a apparatus for manufacturing an image pickup device integrated with lens in which a lens holding part having an optical lens is automatically adjusted with respect to a package on which an imaging chip is mounted so that an optical image from an optical axis adjusting pattern is formed on the image plane of the imaging chip and the lens holding part and the package are fixed to each other with an adhesive used therebetween as a position adjusting member at the adjusted position, and an image pickup device integrated with lens thus manufactured having excellent properties.

### BACKGROUND OF THE INVENTION

The present invention relates to an image pickup device integrated with lens in which an optical lens and a solid state image pickup device are formed integrally and its manufacturing method and manufacturing apparatus.

Generally, the image pickup device integrated with lens using the solid state image pickup device typified by a CCD sensor forms an optical image of a subject captured through an optical lens on an imaging plane of an imaging chip in the solid state image pickup device. And the image pickup device outputs a desired image signal by converting an optical signal into an electrical signal. Especially in recent years, the tendency has been toward reduction in size and increase in pixels of the image pickup device integrated with lens incorporated into an electronic steel camera, a portable terminal or the like. And to obtain a clearer image, it has been required to accurately match an optical axis of the optical lens with that of the imaging chip.

FIG. 5 is a cross-sectional side view showing general constitution of the image pickup device integrated with lens of this type. In FIG. 5, a top surface of a package 101 has a recess so as to provide a cavity 102. An imaging chip 103 is mounted within the cavity 102. The imaging chip 103 is fixed to a bottom surface of the cavity 102 with an adhesive 104. The imaging chip 103 is electrically connected to a lead 105 through a bonding wire (for example, gold wire) not shown. An optical lens 106 is held by a lens holding part 107 so as to be opposed to an imaging plane 103a of the imaging chip 103. The lens holding part 107 has a cross section in the form of an arch and is mounted within the cavity 102 of the package 101 so as to pass over the imaging chip 103.

In one conventional manufacturing method for assembling the solid state image pickup device and the optical lens, accuracy of position of assembling is ensured by forming a protrusion as a reference plane on a part of the package. For example, the Official Gazette of Japanese Unexamined Patent Publication No. Hei 10-321825 discloses such manufacturing method.

FIG. 6 shows the conventional method for assembling the solid state image pickup device and the optical lens to the package, which is disclosed in the Official Gazette of Japanese Unexamined Patent Publication No. Hei 10-321825. Components in FIG. 6 common to those in FIG. 5 in function and constitution are given the same reference numerals. The following description will be performed referring to FIG. 6.

In the conventional image pickup device integrated with lens shown in FIG. 6, a pair of protrusions 109 and 109 are formed on the bottom face of the cavity 102 of the package 101 and upper end faces 109a and 109a of the protrusions 109, 109 are set as reference planes in the optical axis direction. To the package 101 thus constituted, a lower end face of a chip suction-jig 110 that holds the imaging chip 103 by suction contacts with the upper end face 109a of the protrusion 109 as a reference plane. At this time, the imaging plane 103a of the imaging chip 103 is adhered by suction to the lower end face of the chip suction-jig 110. In this manner, the upper end face 109a of the protrusion 109 is contacted with the lower end face of a chip suction-jig 110 to position the imaging chip 103 and the imaging chip 103 is fixed at a desired position on the package 101 with the adhesive 104.

Similarly to the imaging chip 103, the lens holding part 107 that holds the optical lens 106 is also held and sucked by a suction-jig (not shown), and contacts with the upper end face 109a as a reference plane to be mounted in the package 101.

In the above-mentioned conventional manufacturing method of the image pickup device integrated with lens, since a relative distance between the imaging chip 103 and the optical lens 106 in the optical axis direction varies due to variations in size of the lens holding part 107, disadvantageously, the imaging plane 103a of the imaging chip 103 cannot be positioned at a focal point of the optical lens 106 with high precision.

As a measures against this problem, the lens holding part is provided with a mechanism of adjusting the position of the optical lens previously. When the image pickup device integrated with lens is manufactured by use of such lens holding part having the positioning mechanism for the optical lens, the image pickup device integrated with lens is assembled and manufactured by fixing the lens holding part to the package to which the imaging chip is fastened, and then the position of the optical lens is adjusted by the operator in a separate process. In this case, the operator adjusts focal distance between the imaging chip and the optical lens by changing the position of the optical lens by use of the positioning mechanism for the optical lens, which is located in the lens holding part, while viewing an image for adjustment picked up on the imaging chip. However, the manufacturing method of the image pickup device integrated with lens according to such positioning method further requires an adjusting process after assembling, and such adjustment of focal distance depends on skill of each operator greatly, thereby causing increase in manufacturing time and cost.

### SUMMARY OF THE INVENTION

The present invention intends to solve the problem of the conventional manufacturing method of the image pickup device integrated with lens and provide an image pickup device integrated with lens that can obtain an excellent image without the need to perform further positional adjustment of an optical lens after mounting by matching optical axes of an optical lens and an imaging chip in mounting irrespective of dimensional accuracy of components, and manufacturing method and manufacturing apparatus thereof.

To achieve the above-mentioned object, the manufacturing method of the image pickup device integrated with lens from one aspect of the present invention is a manufacturing method of the image pickup device integrated with lens comprising a package on which an imaging chip is mounted, and a lens holding part having an optical lens for forming an optical image on an imaging plane of the above-mentioned imaging chip and being mounted to the above-mentioned package so that the above-mentioned optical lens is opposed to the imaging plane of the above-mentioned imaging chip and this manufacturing method has the steps of
fixing the above-mentioned package on which the above-mentioned imaging chip is mounted to a stage and electrically connecting a connecting terminal of the above-mentioned stage to the above-mentioned imaging chip;
attaching the above-mentioned lens holding part to a component holding jig;
forming an optical image sent from an optical axis adjusting pattern on the imaging plane of the above-mentioned imaging chip;
determining an image signal of the above-mentioned imaging chip output from the above-mentioned connecting terminal;
moving and adjusting the above-mentioned component holding jig that holds the above-mentioned lens holding part with respect to the imaging plane of the above-mentioned imaging chip on the basis of result of the above-mentioned determination; and
fixing the above-mentioned package and the above-mentioned lens holding part after the above-mentioned movement and adjustment.

In the manufacturing method of the image pickup device integrated with lens according to the present invention thus constituted, since the position of the optical lens and the imaging chip is adjusted based on the image signal obtained from the imaging chip so as to match both optical axes with each other, the image pickup device integrated with lens capable of outputting an excellent image irrespective of dimensional accuracy of components can be provided.

A manufacturing method of the image pickup device integrated with lens from another aspect of the present invention is a manufacturing method of the image pickup device integrated with lens comprising a package on which an imaging chip is mounted, and a lens holding part having an optical lens for forming an optical image on an imaging plane of the above-mentioned imaging chip and being mounted to the above-mentioned package so that the above-mentioned optical lens is opposed to the imaging plane of the above-mentioned imaging chip and this manufacturing method has the steps of
fixing the above-mentioned lens holding part to a stage;
attaching the above-mentioned package on which the above-mentioned imaging chip is mounted to a component holding jig and electrically connecting a connecting terminal of the above-mentioned component holding jig to the above-mentioned imaging chip;
forming an optical image sent from an optical axis adjusting pattern on the imaging plane of the above-mentioned imaging chip;
determining an image signal of the above-mentioned imaging chip output from the above-mentioned connecting terminal;
moving and adjusting the above-mentioned component holding jig that holds the above-mentioned package with respect to the imaging plane of the above-mentioned imaging chip on the basis of result of the above-mentioned determination; and
fixing the above-mentioned package and the above-mentioned lens holding part after the above-mentioned movement and adjustment.

In the manufacturing method of the image pickup device integrated with lens according to the present invention thus constituted, since the position of the optical lens and the imaging chip is adjusted based on the image signal obtained from the imaging chip so as to match both optical axes with each other, the image pickup device integrated with lens capable of outputting an excellent image irrespective of dimensional accuracy of components can be provided.

A apparatus for manufacturing the image pickup device integrated with lens from one aspect of the present invention is a apparatus for manufacturing the image pickup device integrated with lens comprising a package on which an imaging chip is mounted, and a lens holding part having an optical lens for forming an optical image on an imaging plane of the above-mentioned imaging chip and being mounted to the above-mentioned package so that the above-mentioned optical lens is opposed to the imaging plane of the above-mentioned imaging chip, and this manufacturing apparatus has:
a stage to which the above-mentioned package that mounts the above-mentioned imaging chip thereon is fixed and which has a connecting terminal electrically connected to the above-mentioned imaging chip;
a component holding jig to which the above-mentioned lens holding part is mounted and which has a light inlet part for letting in an optical image from an optical axis adjusting pattern to the imaging plane of the above-mentioned imaging chip;
a signal processing part electrically connected to the above-mentioned connecting terminal of the above-mentioned stage for processing an image signal from the above-mentioned imaging chip;
an automatic determining part for receiving the image signal from the above-mentioned signal processing part and determining the above-mentioned image signal; and
a driving part for moving and adjusting the above-mentioned component holding jig with respect to the imaging plane of the above-mentioned imaging chip on the basis of the signal sent from the above-mentioned automatic determining part.

In the apparatus for manufacturing the image pickup device integrated with lens according to the present invention thus constituted, the image pickup device integrated with lens with high precision and excellent properties can be provided by comparing the image signal obtained from the imaging chip with the reference signal and adjusting the position of the optical lens and the imaging chip based on the comparison result.

A apparatus for manufacturing the image pickup device integrated with lens from another aspect of the present invention is a apparatus for manufacturing the image pickup device integrated with lens comprising a package on which an imaging chip is mounted, and a lens holding part having an optical lens for forming an optical image on an imaging plane of the above-mentioned imaging chip and being mounted to the above-mentioned package so that the above-mentioned optical lens is opposed to the imaging plane of the above-mentioned imaging chip, and this manufacturing apparatus has:
a stage to which the above-mentioned lens holding part is fixed and which has a light inlet part for letting in an optical image from an optical axis adjusting pattern to the imaging plane of the above-mentioned imaging chip;
a component holding jig to which the above-mentioned package that mounts the above-mentioned imaging chip thereon is mounted and which has a connecting terminal electrically connected to the above-mentioned imaging chip;
a signal processing part electrically connected to the above-mentioned connecting terminal of the above-mentioned component holding jig for processing an image signal from the above-mentioned imaging chip;
an automatic determining part for receiving the image signal from the above-mentioned signal processing part and determining the above-mentioned image signal; and
a driving part for moving and adjusting the above-mentioned component holding jig with respect to the imaging plane of the above-mentioned imaging chip on the basis of the signal from the above-mentioned automatic determining part.

In the apparatus for manufacturing the image pickup device integrated with lens according to the present invention thus constituted, the image pickup device integrated with lens with high precision and excellent properties can be provided by comparing the image signal obtained from the imaging chip with the reference signal and adjusting the position of the optical lens and the imaging chip based on the comparison result.

A image pickup device integrated with lens according to the present invention has: a package on which an imaging chip is mounted;
an optical lens for forming an optical image on an imaging plane of the above-mentioned imaging chip;
a lens holding part mounted to the above-mentioned package so that the above-mentioned optical lens is opposed to the imaging plane of the above-mentioned imaging chip; and
a position adjusting member for disposing between the above-mentioned lens holding part and the above-mentioned package, and for bonding the above-mentioned lens holding part and the above-mentioned package.

Since the image pickup device integrated with lens thus constituted can provide an excellent image irrespective of dimensional accuracy of components since the adhesive between the lens holding part and the package serves as the position adjusting member.

While the novel features of the invention are set forth particularly in the appended claims, the invention, both as to configuration and content, will be better understood and appreciated, along with other objects and features thereof, from the following detailed description taken in conjunction with the drawings.

### BRIEF DESCRIPTION OF THE DRAWINGS

FIG. 1 is a view for illustrating a manufacturing method and a apparatus for manufacturing an image pickup device integrated with lens in accordance with a preferred first embodiment of the present invention;

FIG. 2 is a view for showing relative driving direction of an optical lens and an imaging chip during adjusting operation in the manufacturing method of the image pickup device integrated with lens in accordance with the preferred first embodiment of the present invention;

FIG. 3 is a block diagram for showing constitution of an automatic determining means for automatically determining positional relationship between the imaging plane and the optical lens in the apparatus for manufacturing the image pickup device integrated with lens in accordance with the preferred first embodiment of the present invention;

FIG. 4 is a view for illustrating a manufacturing method and a apparatus for manufacturing an image pickup device integrated with lens in accordance with a preferred second embodiment of the present invention;

FIG. 5 is the cross-sectional side view for showing constitution of a conventional image pickup device integrated with lens; and

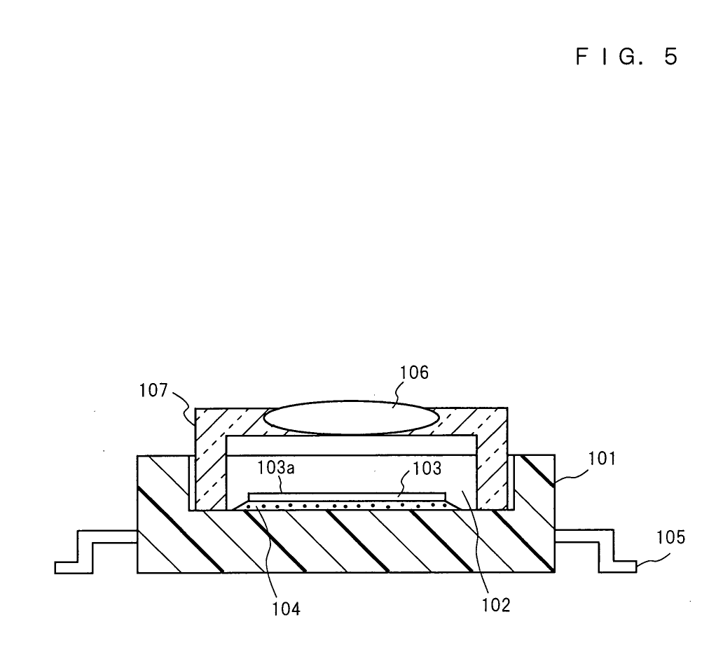

FIG. 6 is the view for illustrating a manufacturing method of the conventional image pickup device integrated with lens.

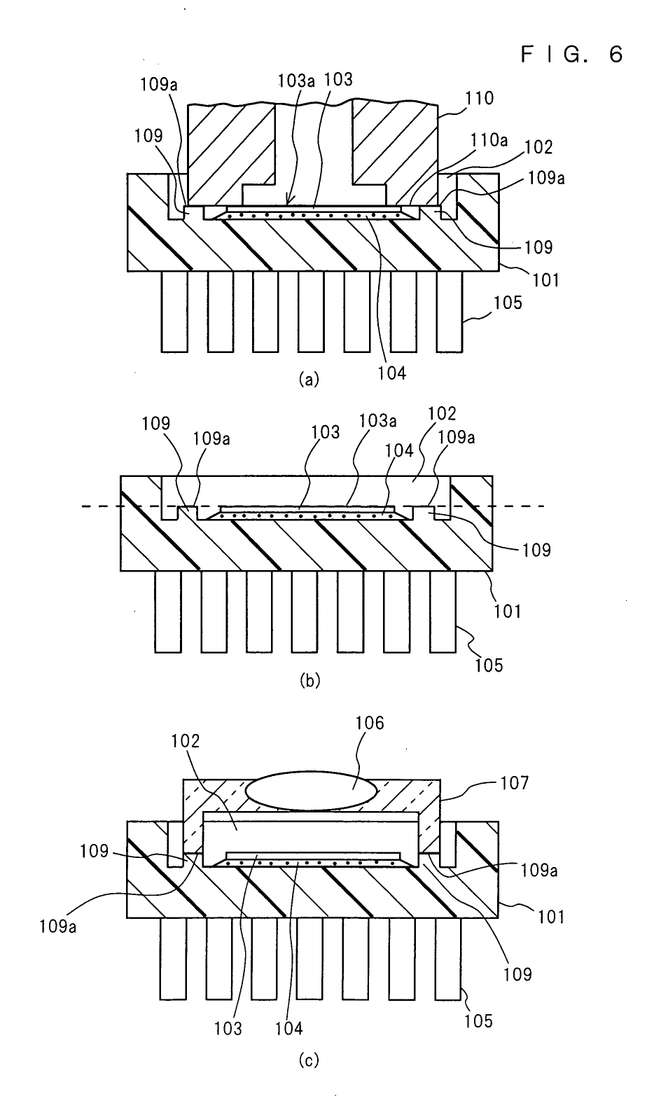

It will be recognized that some or all of the Figures are schematic representations for purposes of illustration and do not necessarily depict the actual relative sizes or locations of the elements shown.

### DETAILED DESCRIPTION OF THE INVENTION

Preferred embodiments of the present invention will be described referring to the appended figures below.

<<First Embodiment>>

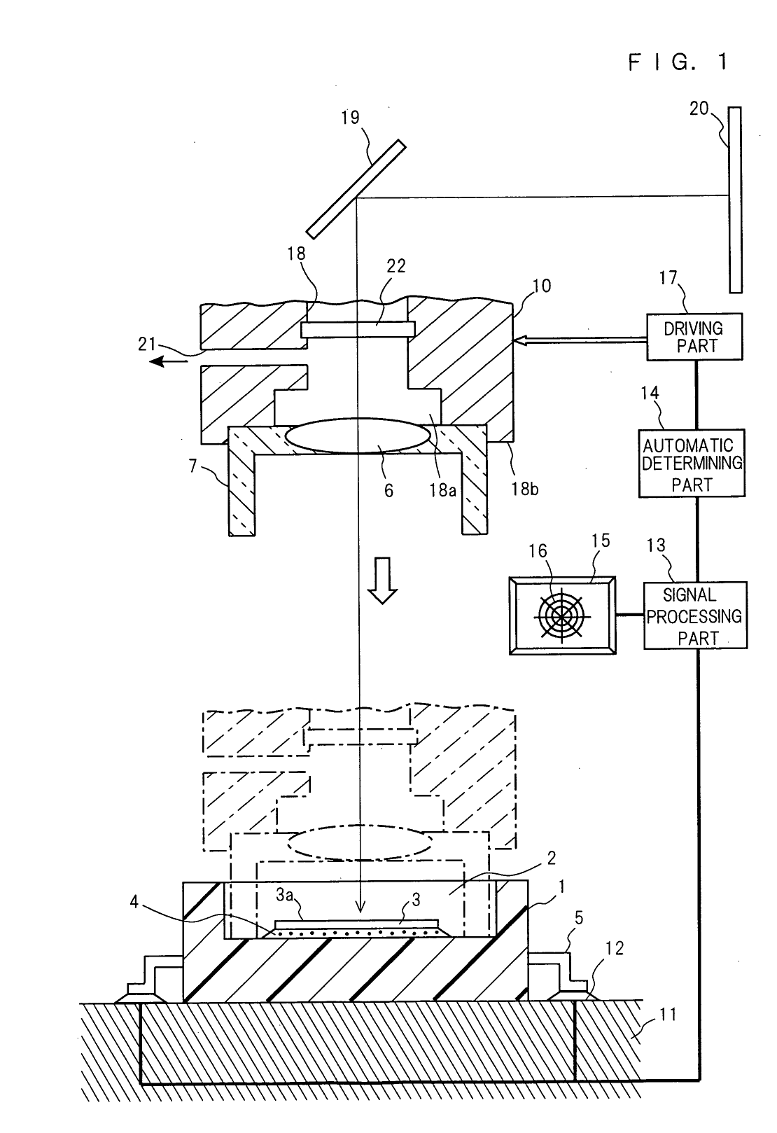

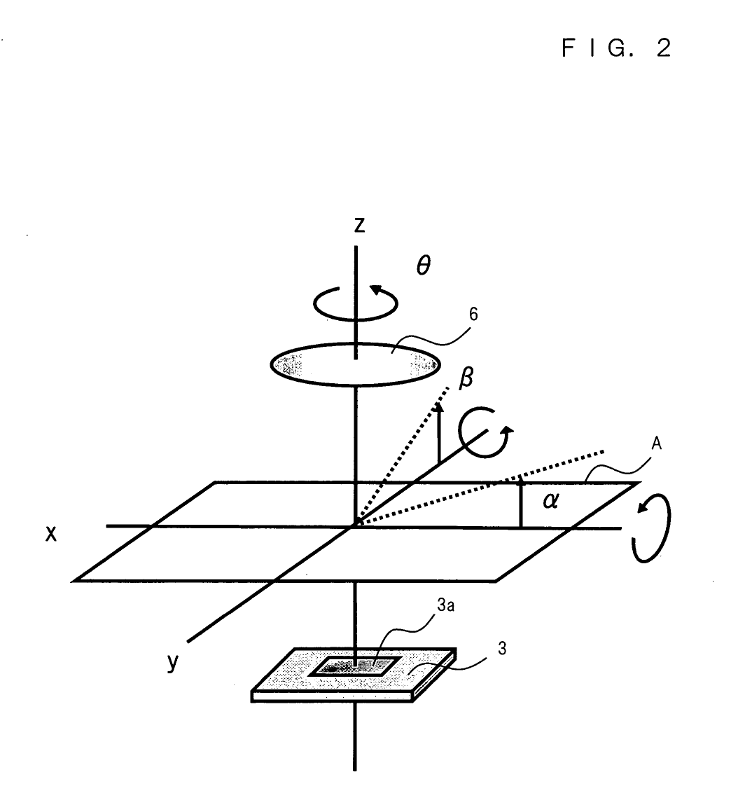

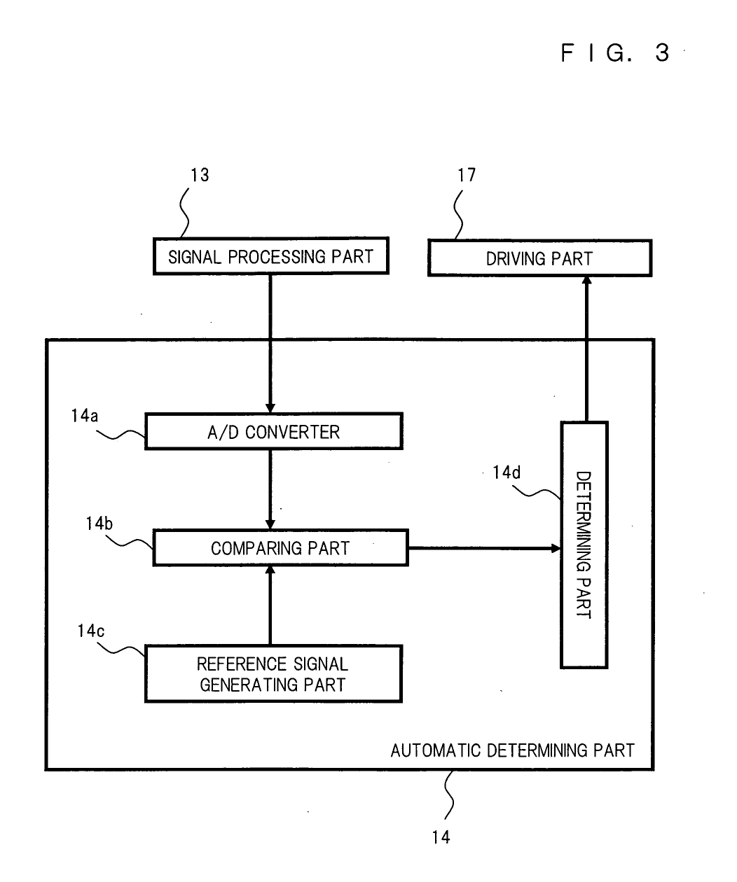

FIG. 1 is a view for illustrating a manufacturing method of an image pickup device integrated with lens in accordance with a preferred first embodiment of the present invention. FIG. 2 is a view for illustrating positional and angular adjustment of an optical lens with respect to an imaging chip. FIG. 3 is a block diagram for showing constitution of an automatic determining part in a apparatus for manufacturing the image pickup device integrated with lens.

In the image pickup device integrated with lens in accordance with the first embodiment, a top surface of a package 1 has a recess so as to provide a cavity 2. An imaging chip 3 is mounted in the cavity 2. According to the method of mounting the imaging chip 3 in the cavity 2, a chip suction-jig that holds the imaging chip 3 by suction is located at a desired position with respect to the package 1 to position the imaging chip 3 and an adhesive 4 is applied between the imaging chip 3 and the bottom face of the cavity 2 of the package 1 so as to fix them to each other. This positioning of the imaging chip 3 may be performed by hitting an end face of the chip suction-jig against an end face of the package 1 as a reference plane. In the present invention, however, since the optical lens 6 is disposed at a proper position and angle with respect to an imaging place 3a of the imaging chip 3, the imaging chip 3 need not be positioned with respect to the package 1 with high precision.

FIG. 1 is a view for showing the image pickup device integrated with lens in process of manufacturing and shows the state in which the imaging chip 3 is fixed with the adhesive 4 at a desired position in the recessed cavity 2 formed on the package 1.

As shown in FIG. 1, the package 1 is fastened to a mounting stage 11 as a stage for mounting in the apparatus for manufacturing the image pickup device integrated with lens. Electrical contacts 12 as a connecting terminal are formed on the mounting stage 11 and connected to a signal processing part 13 having functions necessary for various controls and image-forming which comprises a drive power supply generating circuit, a synchronization signal generating circuit and a signal amplifying circuit. The imaging chip 3 mounted to the package 1 is connected to the electrical contact 12 through a lead 5 and constituted so that an optical image on the imaging plane of the imaging chip 3 is converted into an electrical signal to be output from the electrical contact 12. In the first embodiment, the electrical contact 12 on the mounting stage 11 is detachably connected to the lead 5 led out from the package 1 in the form of a clip. Therefore, the imaging chip 3 mounted to the package 1 is constituted so that the electrical contacts 12 can output an image signal and perform the same operation as the imaging operation in the complete image pickup device integrated with lens.

As shown in FIG. 1, the signal processing part 13 is connected to an automatic determining part 14 and a monitor 15 and an image 16 taken by the imaging chip 3 is output to the monitor 15. Therefore, with the configuration of the apparatus for manufacturing the image pickup device integrated with lens in accordance with the first embodiment, the operator can check distortion, focusing state, etc. of the image while viewing the image on the monitor 15.

A driving part 17 is connected to the automatic determining part 14 and can move a component holding jig 10 that holds the lens holding part 7 by suction to an arbitrary position. FIG. 2 shows the direction of positional and angular adjustment of the optical lens 6 with respect to the imaging plane 3a of the imaging chip 3 schematically. As shown in FIG. 2, in the first embodiment, it is configured so that the driving part 17 can move the component holding jig 10 in the linear directions along each of three axes that are directions of X and Y axes on a plane A parallel to the imaging plane 3a and a direction of Z axis orthogonal to the plane A (height direction), as well as in the three rotational directions around each of three axes that are a rotational direction of β around X axis (pitch direction around X axis), a rotational direction of α around Y axis (pitch direction around Y axis) and a rotational direction of θ around Z axis (pitch direction around Z axis).

The component holding jig 10 in accordance with the first embodiment has a through hole 18 as a light inlet part that allows an optical image sent from an optical axis adjusting pattern 20 described later to pass therethrough. The through hole 18 communicates with a vacuum port 21 for producing a vacuum. Further, to ensure separation of light path from suction path, a translucent board 22 formed of translucent material is disposed at the through hole 18. The chip suction-jig that holds the imaging chip 3 by suction and mounts the imaging chip 3 to the package 1 may be also used as the component holding jig 10.

As mentioned above, the component holding jig 10 in accordance with the first embodiment has the function of holding the lens holding part 7 as a mounted component, for example, by producing a vacuum and the configuration in which an optical image from the optical axis adjusting pattern 20 that is reflected by a mirror 19 is formed on the imaging plane 3a of the imaging chip 3 on the mounting stage 11 through the through hole 18 as a light inlet part.

FIG. 3 is a block diagram for showing configuration of the automatic determining part 14 in the manufacturing apparatus in accordance with the first embodiment. The automatic determining part 14 converts the image signal input from the imaging chip 3 via the signal processing part 13 from analog to digital by using an A/D converter 14a and outputs the converted signal to a comparing part 14b. A reference signal generating part 14c generates a reference signal on each of adjustment items such as position, distortion, linearity, contrast and focusing of the image of the optical axis adjusting pattern 20 and outputs the signal to the comparing part 14b. The comparing part 14b compares the image signal sent from the imaging chip 3 with the reference signal and outputs a signal showing whether or not each adjustment item falls within a range of reference values to a determining part 14d. The determining part 14d determines whether or not each adjustment item is adjusted properly, evaluates by each adjustment item and comprehensively and outputs an electrical signal to the driving part 17 according to the evaluation result.

Next, the manufacturing method of the image pickup device integrated with lens after the imaging chip 3 is mounted in the cavity 2 of the package 1 will be described.

In the apparatus for manufacturing the image pickup device integrated with lens in accordance with the first embodiment, as shown in FIG. 1, in the state in which the imaging chip 3 is mounted in the cavity 2 of the package 1, an optical image on the optical axis adjusting pattern 20 can be formed on the imaging plane 3a of the imaging chip 3 through the through hole 18 as a light inlet part of the component holding jig 10. At this time, the image 16 of the optical axis adjusting pattern 20 can be recognized on the monitor 15.

Firstly, the package 1 is fixed to the mounting stage 11 so that the imaging plane 3a of the imaging chip 3 secured to the package 1 is opposed to the lens holding part 7, that is, the imaging plane 3 is opposed to the component holding jig 10. At this time, the imaging chip 3 has been electrically connected to the lead 5 of the package 1 by means of wire bonding in advance. Alternatively, the imaging chip 3 may be electrically connected to the lead 5 of the package 1 by means of flip chip bonding.

In the first embodiment, it is configured so that the bottom face of the package 1 is made to fix in contact with the upper face of the mounting stage 11 by fixing means such as vacuum suction and at the same time, the electrical contact 12 formed on the mounting stage 11 electrically contacts with the lead 5 through plastic deformation of the lead 5. As a result, the imaging chip 3 secured to the package 1 can operate in the same manner as the imaging chip in the complete image pickup device integrated with lens and therefore the formed image 16 can be displayed on the monitor 15 through the signal processing part 13.

In the manufacturing method of the present invention, electrical connection between the lead 5 of the package 1 and the electrical contact 12 of the mounting stage 11 is not limited to mere contact and electrical connection by using clamp function is acceptable.

Next, the component holding jig 10 holds the lens holding part 7 in a desired state. An opening 18a is formed in the through hole 18 as a light inlet part of the component holding jig 10 on the side opposed to the mounting stage 11. The opening 18a has a larger internal diameter than the through hole 18 and is formed so that the lower end face of the component holding jig 10 comes in contact with the outer periphery of the lens holding part 7. A protrusion 18b for positioning the outer periphery of the lens holding part 7 is formed on the lower end face of the component holding jig 10. The component holding jig 10 thus constituted holds the lens holding part 7 as a mounted component so that the joint surface of the lens holding part 7 with the package 1 faces the mounting stage side (downward direction).

In the state the component holding jig 10 holds the lens holding part 7, when an optical image of the optical axis adjusting pattern 20 is formed on the imaging plane 3a through the optical lens 6, it is desirable that the center of the optical image in the light inlet part, that is, the central position of the through hole 18 and that of the optical lens 6 match with each other so as to form an image on the imaging plane 3a without distortion by minimizing positional dependency of the optical lens 6 due to aberration. For this reason, in the first embodiment, the position of the lens holding part 7 is located by forming the protrusion 18b on the component holding jig 10. In this manner, according to the present invention, when the lens holding part 7 is held by the component holding jig 10, a positioning mechanism such as the protrusion 18b as a position locating pin is formed on the joint face of the component holding jig 10 with the lens holding part 7 so that the central position of the optical lens 6 and that of the through hole 18 as a light inlet part match with each other.

Even if the component holding jig 10 is not provided with such extra positioning mechanism, when the component holding jig 10 receives the lens holding part 7, the central position of the optical lens 6 may be matched with the central position with the center of the optical image as the central position of the light inlet part in such a way that images of both the component holding jig 10 and the lens holding part 7 are recognized with a recognition camera to position them.

As a method of holding the lens holding part 7 by the component holding jig 10, vacuum suction is popular. However, mechanical holding method using clamp mechanism is also applicable in the present invention.

In the first embodiment, a hole for vacuum suction formed in the component holding jig 10 communicates with the through hole 18 as the light inlet part. For this reason, the translucent board 22 is provided so that the opening 18a formed in the component holding jig 10 can be maintained under vacuum when the opening 18a is blocked with the lens holding part 7, thereby resulting in that the opening 18a and a part of the light inlet part are hermetically sealed. The translucent board 22 is formed of translucent material capable of transmitting visible light, for example, glass, quartz, polycarbonate, etc.

The translucent board 22 formed in the component holding jig 10 may be provided at an image intaking port (not shown) of the optical axis adjusting pattern 20 to the optical lens 6, that is, between the optical axis adjusting pattern 20 and the mirror 19. The component holding jig 10 itself may be formed of translucent material capable of transmitting visible light, for example, glass, quartz, polycarbonate, etc., and in this case, the through hole as a light inlet part becomes unnecessary.

in the first embodiment, the configuration in which the hole for vacuum suction communicates with the through hole 18 as the light inlet part is described as an example. However, the hole for vacuum suction may be provided separately from the light inlet part or be constituted so as to suck the lens holding part 7 to the component holding jig 10 efficiently with smaller suction force, for example, to suck plural places on the outer periphery of the lens holding part 7.

As shown in FIG. 1, in the manufacturing method of the image pickup device integrated with lens, the component holding jig 10 that holds the lens holding part 7 by suction is made closer to the imaging chip 3 in the package 1 fixed to the mounting stage 11 with a certain distance. At this time, the optical image from the optical axis adjusting pattern 20 reflected by the mirror 19 passes through the through hole 18 as the light inlet part is formed on the imaging plane 3a of the imaging chip 3 through the optical lens 6.

The pattern formed on the imaging plane 3a is converted into an electrical signal by the imaging chip 3 as a clear image and the signal is input to the signal processing part 13. The image signal processed in the signal processing part 13 is input to the automatic determining part 14. To improve the discrimination accuracy in the automatic determining part 14, it is desirable to secure the adequate amount of light incident on the imaging plane 3a, for example, by illuminating the optical axis adjusting pattern 20.

In the case where space enough to place the optical axis adjusting pattern 20 can be ensured in the periphery of the component holding jig 10, it may be configured so that the imaging plane 3a of the imaging chip 3, the optical lens 6 and the through hole 10 as a light inlet part are disposed in a line and the optical axis adjusting pattern 20 is located on the extension line without intervening the mirror 19. In this case, the absence of the mirror 19 enables downsizing of the device, and moreover, since light from the optical axis adjusting pattern 20 reaches onto the imaging plane 3a directly, the amount of light incident on the imaging plane 3a can be easily secured.

As mentioned above, when the optical image of the optical axis adjusting pattern 20 is formed on the imaging chip 3, the image signal generated in the signal processing part 13 is output to the automatic determining part 14 and the monitor 15 and the formed image 16 of the optical axis adjusting pattern 20 is displayed on the monitor 15.

The automatic determining part 14 outputs the image signal sent from the signal processing part 13 to the comparing part 14b through the A/D converter 14a. The reference signal generating part 14c generates and outputs a reference signal to the comparing part 14b. The comparing part 14b compares the image signal obtained from the imaging chip 3 with the reference signal and the determining part 14d determines whether or not each adjustment item is adjusted properly.

As mentioned above, the automatic determining part 14 determines whether or not the optical axis of the imaging plane 3a matches with the optical axis of the optical lens 6 to obtain a desirable image by automatically comparing the image signal with the reference signal.

In comparing the image signal as imaging data with the predefined reference signal for determination, the automatic determining part 14 makes a decision depending on whether or not correlation level (concordance rate) of both signals is a setting value or more.

Moreover, in the automatic determining part 14, after the image incident on the imaging chip 3 from the optical axis adjusting pattern 20 through the optical lens 6 is converted into an electrical signal in the imaging chip 3, the signal is normalized in the A/D converter 14a so that correct determination can be performed irrespective of contrast (intensity) in the image caused by differences in light amount.

In the image converted into the electrical signal in the imaging chip 3, output waveform of the pattern normalized in the A/D converter 14a varies due to differences in position, distortion, linearity, contrast and focusing. For this reason, by obtaining the finite difference between the pattern output from the A/D converter 14a and the pattern of the reference image preset in the reference signal generating part 14c, correlation level (concordance rate) of both patterns can be calculated.

When only the automatic determining part 14 for automatically performing determination operation is used without direct observation of the operator as mentioned above, the monitor 15 may be omitted.

When the automatic determining part 14 compares the image signal obtained from the imaging chip 3 with the reference signal and determines that each adjustment item including as position, distortion, linearity, contrast and focusing does not fall within a range of reference values, the automatic determining part 14 outputs the determination result to the driving part 17 to move the component holding jig 10 by a predetermined position and angle, thereby changing relative position between the optical lens 6 and the imaging plane 3a for adjustment.

Until the difference between the image signal obtained from the imaging chip 3 with the reference signal falls within a range of reference values, adjustment by this feedback control is continued.

For adjustment, as shown in FIG. 2, the adjusting operation with respect to six directions including positional adjusting movement in the directions of X axis and Y axis on a plane A parallel to the imaging plane and the direction of Z axis and rotational movement in the rotational direction of β around X axis (pitch direction around X axis), the rotational direction of α around Y axis (pitch direction around Y axis) and the rotational direction θ around Z axis (pitch direction around Z axis) is performed.

At adjusting operation in the first embodiment, the positional adjusting movement in the direction of X axis is firstly performed. At this time, movement in the directions of other axes is not allowed. In other words, while the component holding jig 10 holding the lens holding part 7 is moved in the direction of X axis, the automatic determining part 14 obtains the finite difference between the pattern of the image signal obtained from the imaging plane 3a by the comparing part 14b in real time and the pattern of the reference signal output from the reference signal generating part 14c to calculate correlation level (concordance rate) of both patterns.

The component holding jig 10 is moved to the position on X axis at which the finite difference between both patterns becomes minimum (maximum correlation level) and subsequently, positional adjusting movement in the direction of Y axis is performed. At this time, movement in the directions of other axes is not allowed. In other words, while the component holding jig 10 holding the lens holding part 7 is moved only in the direction of Y axis, the automatic determining part 14 obtains the finite difference between the pattern of the image signal obtained from the imaging plane 3a by the A/D converter 14a in real time and the pattern of the reference signal output from the reference signal generating part 14c to calculate correlation level (concordance rate) of both patterns. The component holding jig 10 is moved to the position on Y axis at which the finite difference between both patterns becomes minimum (maximum correlation level)

Subsequently, the positional adjusting movement in the direction of Z axis and rotational adjusting movement in the rotational directions of θ, α and β are performed in this order.

In the state where the above-mentioned adjusting operation has finished one cycle, when correlation level (concordance rate) between the pattern of the image signal obtained from the imaging plane 3a of the imaging chip 3 and the pattern of the reference signal output from the reference signal generating part 14c falls within the range of reference values, the positioning operation is finished. When concordance rate exceeds the range of reference values, the above-mentioned adjustment operation starting from the positional adjusting movement in the direction of X axis is started again and repeated until concordance rate falls within the range of reference values.

As a matter of course, even if adjustment operation from the positional adjusting movement in the direction of X axis to the last rotational adjusting movement in the rotating direction of β has not completely finished yet, when correlation level (concordance rate) between the pattern of the electrical signal obtained from the imaging plane 3a and the pattern of the reference signal output from the reference signal generating part 14c falls within the predetermined range of reference values, the positioning operation may be finished at the time.

Although the direction of X axis, the direction of Y axis, the direction of Z axis, the rotating direction of θ, the rotating direction of α and the rotating direction of β are mentioned in this order in the above-mentioned description of adjusting operation for the sake of convenience, the present invention does not limit the adjusting operation to this order and any order of the adjusting operation can achieve the same effect.

Further, as shown in FIG. 1, the apparatus for manufacturing the image pickup device integrated with lens in accordance with the first embodiment is configured so that position and angle of the component holding jig 10 can be moved in the following six directions that are the direction of X axis, the direction of Y axis, the direction of Z axis, the rotating direction of θ, the rotating direction of a and the rotating direction of β by the driving part 17. However, it may be also configured so that the mounting stage 11 can be moved in the above-mentioned six directions, with the component holding jig 10 being fixed.

Furthermore, for improvement in positioning accuracy and operating speed, both of the component holding jig 10 and the mounting stage 11 may be configured so as to move in the above-mentioned six directions.

Alternatively, because of the limited manufacturing equipment and manufacturing cost, the moving mechanism in above-mentioned six directions may be divided in the component holding jig 10 and the mounting stage 11.

As mentioned above, at the time of termination of the adjusting operation, that is, when difference between the image signal obtained from the imaging chip 3 and the reference signal output from the reference signal generating part 14c falls within the range of reference values, the component holding jig 10 is stopped and then the lens holding part 7 is fixed to the package 1 at the position.

Methods of fixing of the lens holding part 7 to the package 1 include fixing with an adhesive. In particular, the fixing method of applying ultraviolet curable resin to the joint face and irradiating ultraviolet ray on the applied area is excellent in small displacement due to shrinkage of resin during curing and fast curing rate.

In the first embodiment, as mentioned above, when the lens holding part 7 is disposed at a predetermined position with respect to the package 1, the lens holding part 7 and the package 1 are fixed to each other so as to have a desired positional relationship by applying the adhesive into the gap between opposed faces of the lens holding part 7 and the package 1 (joint part). Accordingly, in the first embodiment, the adhesive serves as a position adjusting member. In the case where an adhesive is used as a fixing method, it is desirable to dispose an adhesive applying mechanism in the manufacturing apparatus in terms of manufacturing management and workability. Especially, in the case where the fixing method using ultraviolet curable resin is employed, an ultraviolet ray irradiating mechanism is preferably placed in addition to the above-mentioned adhesive applying mechanism. Among ultraviolet curable resin, U-1455 made by Chemitech Co., Ltd. is widely known.

As mentioned above, the lens holding part 7 and the package 1 are fixed to each other with the adhesive after the completion of the adjusting operation and as a result, the mounting operation according to the manufacturing method of the image pickup device integrated with lens of the first embodiment is completed.

The apparatus for manufacturing the image pickup device integrated with lens used in the first embodiment has a higher positioning accuracy (error of 1 μm or less) and a faster mounting speed than conventional devices, though depending on using conditions. Therefore, because of the feature that high-speed mounting is enabled, compared with the case where the operator adjusts the optical axis manually while viewing the real image, a much higher productivity can be achieved.

<<Second Embodiment>>

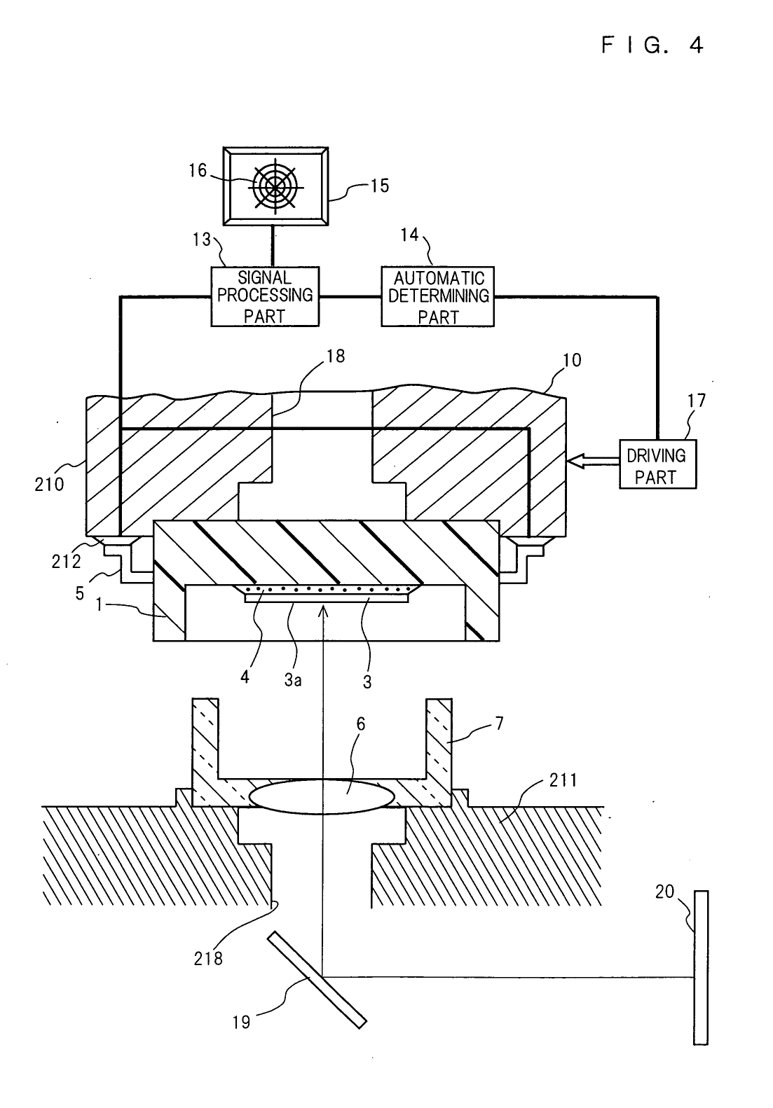

FIG. 4 is a view for illustrating a apparatus for manufacturing an image pickup device integrated with lens in accordance with a preferred second embodiment of the present invention.

The above-mentioned first embodiment describes the configuration in which the lens holding part 7 that holds the optical lens 6 is attached to the component holding jig 10 and the package 1 on which the imaging chip 3 is mounted is held by the mounting stage 11. The manufacturing apparatus in accordance with the second embodiment has the configuration in which the package 1 is held by suction by a component holding jig 210 provided with electrical contacts 212 as a connecting terminal thereon and a through hole 218 as a light inlet part is formed in the mounting stage 211 to fix the lens holding part 7. In this manner, the apparatus for manufacturing the image pickup device integrated with lens in accordance with the second embodiment is configured so that the component holding jig 210 holds the package 1 on which the imaging chip 3 is mounted. And, the imaging chip 3 on the package 1 is disposed at a proper position with respect to the optical lens 6 held by the lens holding part 7 and the lens holding part 7 and the package are fixed to each other with an adhesive according to the same method as manufacturing method of the image pickup device integrated with lens of the first embodiment. In FIG. 4, components having the same function and constitution as the apparatus for manufacturing the image pickup device integrated with lens of the first embodiment are given the same reference numerals and description thereof will be omitted.

In the apparatus for manufacturing the image pickup device integrated with lens of the second embodiment, in addition to the same effect as in the first embodiment, since adjusting operation can be performed in the state where the mirror 19 and the optical axis adjusting pattern 20 along with the optical lens 6 are fixed, adjustment can be carried out with a higher accuracy.

In the manufacturing methods and devices in accordance with the first and second embodiments, to ensure forming accuracy of the image pickup device integrated with lens, positioning is not performed by forming a reference plane on one component and pressing other component onto the reference plane. For this reason, according to the present invention, there is no need to form the reference plane for positioning on the package 1 and lens holding part 7 in the configuration of the image pickup device integrated with lens as a product.

Further, the manufacturing methods and devices in accordance with the first and second embodiments requires no positional adjustment of the optical lens by the operator after assembling. For this reason, there is no need to provide a height adjusting mechanism such as pitch mechanism and screws, which is necessary for the package and lens holding part in the conventional image pickup device integrated with lens, in the image pickup device integrated with lens according to the present invention.

Furthermore, in the manufacturing methods in accordance with the first and second embodiments, the package 1 and the lens holding part 7 are automatically positioned and the adhesive is applied between the positioned package 1 and lens holding part 7 for fixing. In this mounting, a gap of several ten μm to several mm (positional adjusting space) exists between the positioned package 1 and lens holding part 7. The adhesive is applied into the gap so that the positioned package 1 and lens holding part 7 are fixed to each other. Accordingly, the adhesive used for fixing the package 1 and the lens holding part 7 serves as a fixing means of both components as well as a positional adjusting member by entering into the positional adjusting space.

As has been described above, in the manufacturing methods and devices in accordance with the first and second embodiments, a real image is formed in mounting, the image signal of the real image is compared with the reference signal, the lens holding part is mounted to the package to which the imaging chip is fixed while automatically adjusting each of the adjusted item such as position, distortion, linearity, contrast and focusing of the image. Therefore, according to the present invention, the optical axis of the imaging chip and that of the optical lens can be matched accurately without coming under the influence of variations in thickness of the package and chip in the optical axis direction.

Therefore, according to the present invention, adjustment of the optical axes of the optical lens and the imaging chip can be completed concurrently with mounting, thereby requiring no adjustment of focal distance by means of changing the position of the optical lens after component mounting, and as a result, it becomes possible to manufacture the image pickup device integrated with lens generating an excellent image reliably and easily. Further, in the manufacturing method and device according to the present invention, work time necessary for adjustment of focal distance and the number of jigs and measuring instruments and the like can be greatly reduced. As a result, according to the present invention, it becomes possible to provide the image pickup device integrated with lens that achieves component mounting with a high precision at an extremely low price.

Moreover, according to the present invention, there is no need to provide the lens position adjusting mechanism in the lens holding part nor to improve dimensional accuracy of each of the lens holding part and the package since components are not brought into contact for positioning in the manufacturing method. As a result, according to the present invention, it becomes possible to reduce the machining cost of components, thereby providing the image pickup device integrated with lens at an extremely low price.

Generally, for the components of the image pickup device integrated with lens, the optical lens has variations in optical characteristics and the imaging chip has variations in light-receiving characteristics depending on differences of the individual components. Furthermore, even if mechanical positional relationship between the optical lens and imaging plane of the imaging chip is ensured, the image pickup device integrated with lens as a whole has variations in optical characteristics (imaging characteristics). In the manufacturing method of the lens integrated image pickup according to the present invention, since components are mounted while adjustment is made by using a real image, the above-mentioned variations can be coped with and the image pickup device integrated with lens having no variations in quality and output characteristics can be provided.

Although the invention has been described in its preferred form with a certain degree of particularity, it is understood that the present disclosure of the preferred form has been changed in the details of construction and the combination and arrangement of parts may be resorted to without departing from the spirit and the scope of the invention as claimed.

1. A manufacturing method of an image pickup device integrated with lens comprising a package on which an imaging chip is mounted, and a lens holding part which has an optical lens for forming an optical image on an imaging plane of said imaging chip and which is mounted to said package so that said optical lens is opposed to the imaging plane of said imaging chip, comprising the steps of:
fixing said package on which said imaging chip is mounted to a stage and electrically connecting a connecting terminal of said stage to said imaging chip;
attaching said lens holding part to a component holding jig;
forming an optical image sent from an optical axis adjusting pattern on the imaging plane of said imaging chip;
determining an image signal of said imaging chip output from said connecting terminal;
moving and adjusting said component holding jig that holds said lens holding part with respect to the imaging plane of said imaging chip on the basis of result of said determination; and
fixing said package and said lens holding part after said movement and adjustment.

2. The manufacturing method of an image pickup device integrated with lens in accordance with claim 1, wherein said step of moving and adjusting a component holding jig with respect to the imaging plane of said imaging chip comprising the steps of:
moving said lens holding part so that difference between an image signal obtained from said imaging chip and a reference signal falls within the range of reference values; and
fixing said package and said lens holding part when difference between an image signal obtained from said imaging chip and a reference signal falls within the range of reference values.

3. The manufacturing method of an image pickup device integrated with lens in accordance with claim 1, wherein a light inlet part is formed at said component holding jig that holds said lens holding part and an optical image of the optical axis adjusting pattern is formed on the imaging plane of said imaging chip through said light inlet part.

4. A manufacturing method of an image pickup device integrated with lens comprising a package on which an imaging chip is mounted, and a lens holding part which has an optical lens for forming an optical image on an imaging plane of said imaging chip and which is mounted to said package so that said optical lens is opposed to the imaging plane of said imaging chip, comprising the steps of:
fixing said lens holding part to a stage;
attaching said package on which said imaging chip is mounted to a component holding part and electrically connecting a connecting terminal of said component holding jig to said imaging chip;
forming an optical image sent from an optical axis adjusting pattern on the imaging plane of said imaging chip;
determining an image signal of said imaging chip output from said connecting terminal;
moving and adjusting said component holding jig that holds said lens holding part with respect to the imaging plane of said imaging chip on the basis of result of said determination; and
fixing said package and said lens holding part after said movement and adjustment.

5. The manufacturing method of an image pickup device integrated with lens in accordance with claim 4, wherein said step of moving and adjusting a component holding jig with respect to an optical lens comprising the steps of:
moving said lens holding part so that difference between an image signal obtained from said imaging chip and a reference signal falls within the range of reference values; and
fixing said package and said lens holding part when difference between an image signal obtained from said imaging chip and a reference signal falls within the range of reference values.

6. The manufacturing method of an image pickup device integrated with lens in accordance with claim 4, wherein a light inlet part is formed at a stage that holds said lens holding part and an optical image of said optical axis adjusting pattern is formed on the imaging plane of said imaging chip through said light inlet part.

7. The manufacturing method of an image pickup device integrated with lens in accordance with claim 1, wherein said step of comparing an image signal obtained from said imaging chip with a reference signal for determination comprising the steps of:
converting the image signal from said imaging chip from analog to digital;
generating said reference signal of adjusted items such as position, distortion, linearity, contrast and focus of an image; and
comparing the image signal input from said imaging chip with said reference signal and determining or not said adjusted items fall within a range of reference values.

8. The manufacturing method of an image pickup device integrated with lens in accordance with claim 1, wherein said package and said lens holding part are fixed with an ultraviolet curable adhesive after said movement and adjustment.

9. An apparatus for manufacturing an image pickup device integrated with lens comprising a package on which an imaging chip is mounted, and a lens holding part which has an optical lens for forming an optical image on an imaging plane of said imaging chip and which is mounted to said package so that said optical lens is opposed to the imaging plane of said imaging chip, comprising:
a stage to which said package that mounts said imaging chip thereon is fixed and which has a connecting terminal electrically connected to said imaging chip;
a component holding jig to which said lens holding part is mounted and which has a light inlet part for letting in an optical image from an optical axis adjusting pattern to the imaging plane of said imaging chip;
a signal processing part electrically connected to said connecting terminal of said stage for processing an image signal from said imaging chip;
an automatic determining part for receiving the image signal from said signal processing part and determining said image signal; and
a driving part for moving and adjusting said component holding jig with respect to the imaging plane of said imaging chip on the basis of the signal from said automatic determining part.

10. An apparatus for manufacturing an image pickup device integrated with lens comprising a package on which an imaging chip is mounted, and a lens holding part which has an optical lens for forming an optical image on an imaging plane of said imaging chip and which is mounted to said package so that said optical lens is opposed to the imaging plane of said imaging chip, comprising:
a stage to which said lens holding part is fixed and which has a light inlet part for letting in an optical image from an optical axis adjusting pattern to the imaging plane of said imaging chip;
a component holding jig to which said package that mounts said imaging chip thereon is mounted and which has a connecting terminal electrically connected to said imaging chip;
a signal processing part electrically connected to said connecting terminal of said component holding jig for processing an image signal obtained from said imaging chip;
an automatic determining part for receiving the image signal from said signal processing part and determining said image signal; and
a driving part for moving and adjusting said component holding jig with respect to the imaging plane of said imaging chip on the basis of the signal from said automatic determining part.

11. The apparatus for manufacturing an image pickup device integrated with lens in accordance with claim 9 further comprising a fixing mechanism for fixing said package and said lens holding part with an adhesive after movement and adjustment of said component holding jig with said driving part.

12. The apparatus for manufacturing an image pickup device integrated with lens in accordance with claim 9, wherein said automatic determining part comprises:
an A/D converter for converting an image signal sent from said signal processing part from analog to digital;
a reference signal generating part for generating a reference signal of adjusted items such as position, distortion, linearity, contrast and focusing of an image;
a comparing part for comparing said image signal with said reference signal; and
a determining part for determining whether or not each of said adjusted items falls in a range of reference values.

13. The apparatus for manufacturing an image pickup device integrated with lens in accordance with claim 9, wherein said light inlet part is formed of translucent material and the optical image from said optical axis adjusting pattern through said light inlet part is formed on the imaging plane of said imaging chip.

14. A image pickup device integrated with lens comprising:
a package on which an imaging chip is mounted;
an optical lens for forming an optical image on an imaging plane of said imaging chip;
a lens holding part mounted to said package so that said optical lens is opposed to the imaging plane of said imaging chip; and
a position adjusting member for disposing between said lens holding part and said package, and for bonding said lens holding part and said package.

15. The image pickup device integrated with lens in accordance with claim 14, wherein said position adjusting member disposed between said lens holding part and said package is formed of an ultraviolet curable adhesive.
